(19) United States
(12) Patent Application Publication
(10) Pub. No.: US 2016/0218882 A1
(43) Pub. Date: Jul. 28, 2016

(54) METHODS AND SYSTEMS FOR INSTALLING SOFTWARE

(71) Applicant: CANON KABUSHIKI KAISHA, Tokyo (JP)

(72) Inventor: Loren A. Wood, Lakewood, CA (US)

(21) Appl. No.: 14/604,550

(22) Filed: Jan. 23, 2015

(51) Int. Cl. H04L 9/32; G06F 9/445

(52) U.S. Cl. CPC H04L 9/3268; G06F 8/61; H04L 9/3247; H04L 2209/24; H04L 2209/72; H04L 2209/64

(57) ABSTRACT

Methods and systems for installing software extract a software signing certificate from a software package; extract an installation application software signing certificate from a software installation application installed on a computing device; determine whether the software signing certificate matches the installation application software signing certificate; and responsive to determining that the software signing certificate matches the installation application software signing certificate, install software included in the software package via the software installation application on the computing device.

### BACKGROUND

1. Field of the Disclosure

The present disclosure relates generally to installing software.

2. Background

An operating system which allows a silent installation of software has been introduced. In order to silently install software on a computing device, the operating system requires the public key signing certificate of the software to be installed locally on the computing device. The certificate may be installed locally on a computing device by having a user manually install the certificate into a local certificate store of the computing device or by having an installation application extract the public key signing certificate from the signed software and install the extracted certificate into a local certificate store. However, manually installing the certificate is inconvenient and time consuming for the users. On the other hand, installing the public key signing certificate that was extracted from the signed software into the local certificate store is unsafe, because the certificate may be tampered with.

### SUMMARY

In one embodiment, a method for installing software comprises extracting a software signing certificate from a software package, extracting an installation application software signing certificate from a software installation application installed on a computing device, determining whether the software signing certificate matches the installation application software signing certificate, and responsive to determining that the software signing certificate matches the installation application software signing certificate, installing software included in the software package via the software installation application on the computing device.

In one embodiment, a system for installing software comprises one or more computer-readable media and one or more processors that are coupled to the computer-readable media and that are configured to cause the system to extract a software signing certificate from a software package, extract an installation application software signing certificate from a software installation application, determine whether the software signing certificate matches the installation application software signing certificate, and responsive to determining that the software signing certificate matches the installation application software signing certificate, install software included in the software package via the software installation application on the computing device.

In one embodiment, one or more computer-readable media store computer-executable instructions that, when executed by one or more computing devices, cause the computing devices to perform operations that comprise extracting a software signing certificate from a software package, extracting an installation application software signing certificate from a software installation application installed on a computing device, determining whether the software signing certificate matches the installation application software signing certificate, and responsive to determining that the software signing certificate matches the installation application software signing certificate, installing software included in the software package via the software installation application on the computing device.

### BRIEF DESCRIPTION OF THE DRAWINGS

FIG. 1 is a block diagram illustrating an example embodiment of a system for installing software.

FIG. 2 is a flowchart illustrating an example embodiment of a method for installing software.

FIGS. 3A-C illustrate example embodiments of error messages.

FIG. 4 illustrates an example embodiment of a system for installing software.

FIG. 5 illustrates an example embodiment of a system for installing software.

### DESCRIPTION

The following disclosure describes certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

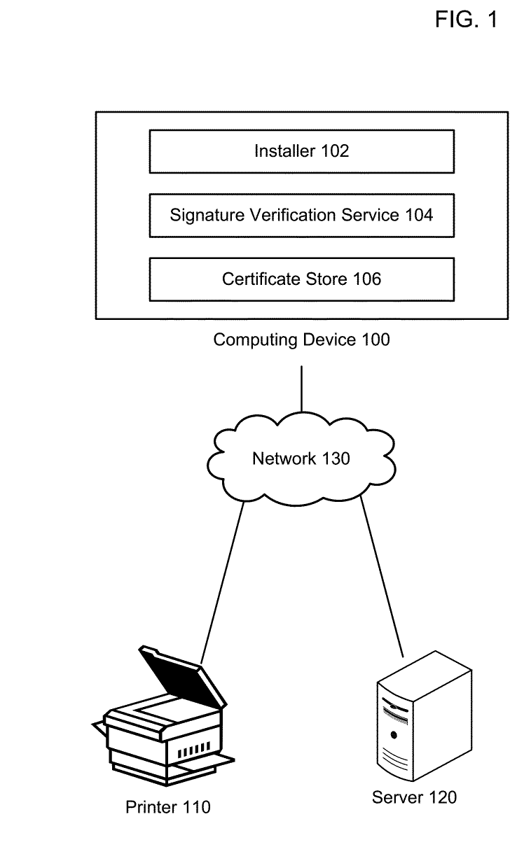

FIG. 1 is a block diagram illustrating an example embodiment of a system for installing software. The system for installing software includes a computing device 100, one or more printers 110, one or more servers 120, and a network 130.

The computing device 100 may be any computing device, such as a desktop computer, a laptop computer, a tablet, a personal digital assistant (PDA), and a mobile phone. The computing device 100 includes a software installation application 102, a signature verification service 104, and a certificate store 106.

The software installation application 102 (also referred to as “installer 102”) is an application program for installing software. When a software package that includes software that is to be installed is loaded onto the computing device 100, the installer 102 is invoked. The software package may be loaded onto the computing device, for example, by downloading from a website (e.g., the server 130) or by reading from a physical medium, such as an optical disk or a magnetic disk. In this embodiment, the software is a print driver used to provide selections of print settings and generate print job data (e.g., Print Description Language) for the printers 110. However, in some embodiments, the software may be any other software that can be installed on a computing device using the installer 102. When the installer 102 is invoked, the installer 102 launches the signature verification service 104.

The signature verification service 104 is configured to verify the validity of the software signature (e.g., a digital signature) that was used to sign the certificate associated with the software to be installed. The software signature is verified, for example, by decrypting the software signature using the signing authority's public key and comparing the hash function included in the software with the hash function that resulted from decrypting the software signature. If both of the hash functions are equal, the software signature is determined to be valid. In addition, the signature verification service 104 may verify the validity of the installer signature (e.g., a digital signature) that was used to sign the certificate associated with the installer 102 in the same or similar manner as the signature verification service 104 verifies the software signature. The signature verification service 104 returns the results of the verification to the installer 102.

If both the software signature and the installer signature are determined to be valid by the signature verification service 104, the installer 102 decrypts the software signing certificate using the software signature and decrypts the installer signing certificate using the installer signature. The installer 102 further extracts a public key from the software signing certificate and a public key from the installer signing certificate. Then, the installer 102 compares the public key extracted from the software signing certificate and the public key extracted from the installer signing certificate. If the public key extracted from the software signing certificate and the public key extracted from the installer signing certificate are equal, the installer 102 stores the software signing certificate in the certificate store 106. The certificate store 106 is configured to locally store software signing certificates in the computing device 100. When the software signing certificate is stored in the certificate store 106, the installer 102 installs the software to the computing device 100.

The entities in the system for installing software may communicate via wired or wireless channels (e.g., the network 130) that allow the exchange of data between the entities.

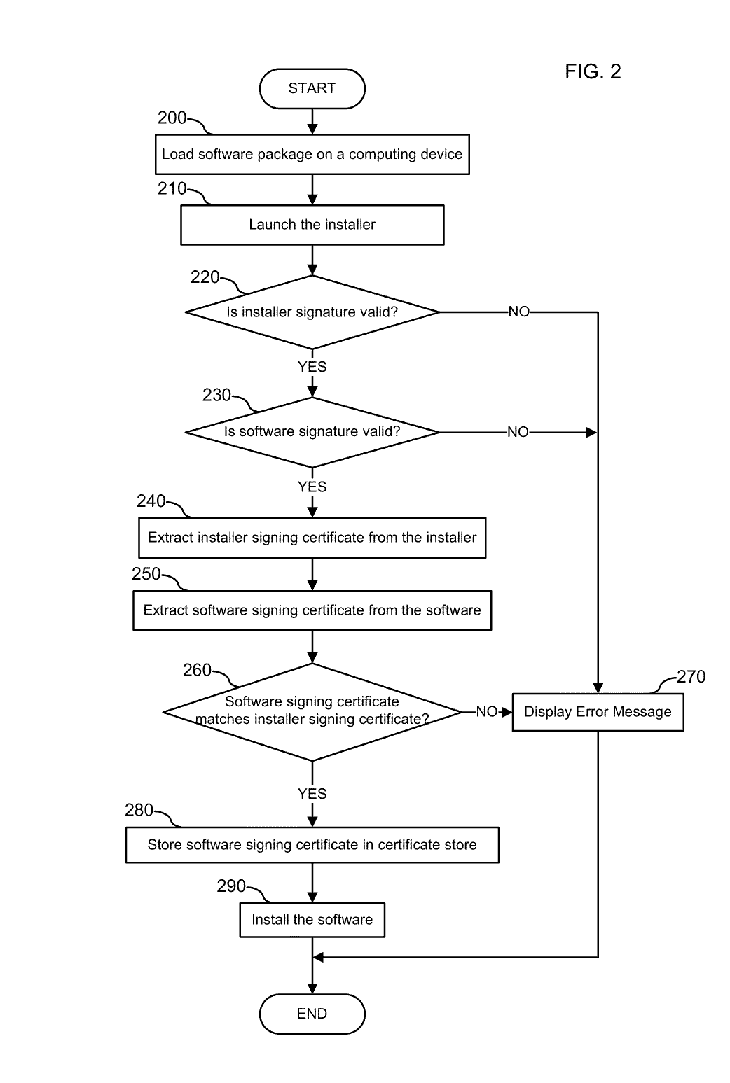

FIG. 2 is a flowchart illustrating an example embodiment of a method for installing software. The blocks of this method and the other methods described herein may be performed by one or more computing devices, for example the systems and devices described herein. Also, although this method and the other methods described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of this method and the other methods described herein may omit blocks, add blocks, change the order of the blocks, combine blocks, or divide blocks into more blocks.

Beginning in block 200, a software package is loaded on a computing device. The software package includes one or more files, such as an executable file (e.g., setup.exe), that are necessary to execute the software. Next, in block 210, an installer (e.g., software installation application) of a computing device is launched. The installer may be invoked when the executable file included in the software package is received.

Moving on to block 220, whether the signature (e.g., a digital signature) of the installer is valid is determined by the signature verification service. The signature of the installer was used to sign the signing certificate associated with the installer. If the signature of the installer is determined to be valid (block 220=YES), the flow proceeds to block 230. Otherwise, if the signature is determined to not be valid (block 220=NO), the flow moves to block 270.

Further, in block 230, whether the signature (e.g., a digital signature) of the software package is valid is determined. The signature of the software package is used to sign the signing certificate associated with the software package. If the signature of the software package is determined to be valid (block 230=YES), the flow proceeds to block 240. Otherwise, if the signature of the software package is determined to be not valid (block 230=NO), the flow moves to block 270.

In block 240, the installer signing certificate is extracted from the installer using the validated installer signature. Next, in block 250, the software signing certificate is extracted from the software package using the validated software signature. Then, in block 260, whether the extracted software signing certificate matches the extracted installer signing certificate is determined. To determine whether the extracted software signing certificate matches the extracted installer signing certificate, the public key of the software signing certificate is extracted from the software signing certificate and compared to the public key of the installer signing certificate extracted from the installer signing certificate. If the extracted software signing certificate matches the extracted installer signing certificate (block 260=YES), the flow proceeds to block 280. Otherwise, if the extracted software signing certificate does not match the extracted installer signing certificate (block 260=NO), the flow moves to block 270, where an error message is displayed to the user.

In block 280, the software signing certificate is stored in a certificate store of the computing device. Finally, in block 290, the software is installed to the computing device.

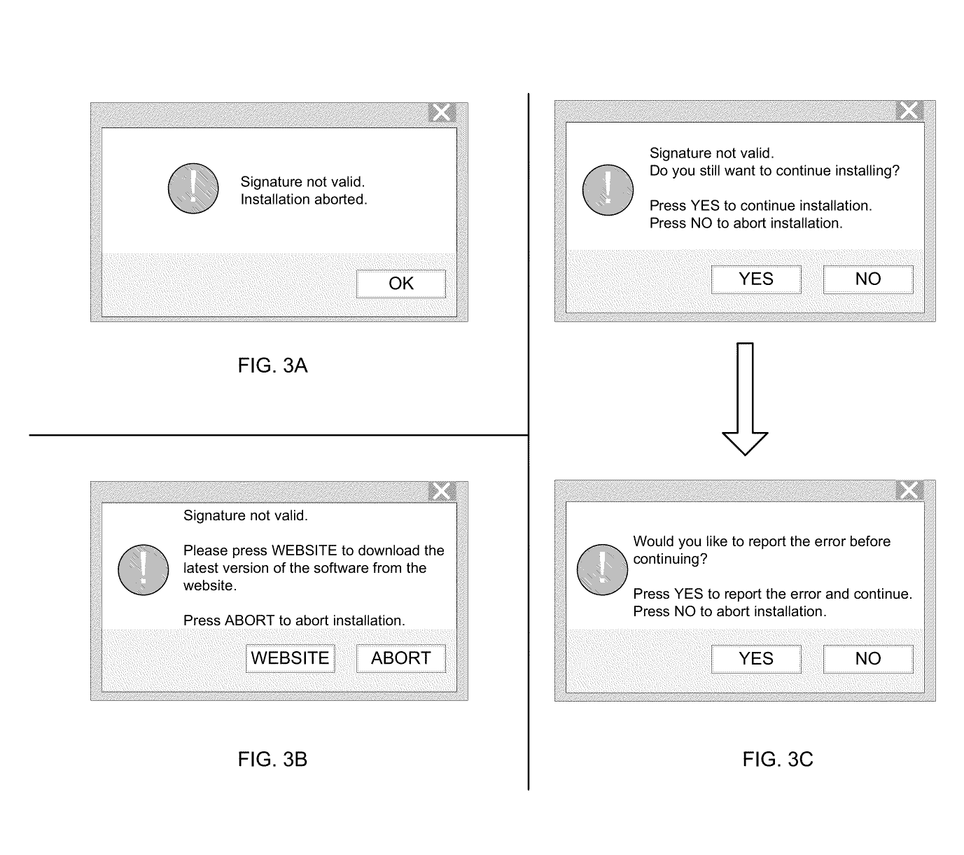

FIGS. 3A-C illustrate example embodiments of error messages. The error messages are presented via I/O interfaces of the computing device if at least one of the following occurs in the process of installing software: (1) the software signature or the installer signature is not signed by a digital signature; (2) the software signature or the installer signature is found to be invalid by the signature verification service; and (3) the public key of the software signing certificate and the public key of the installer signing certificate are not equal.

The error message of FIG. 3A notifies the user that the installation of the software is aborted. In this embodiment, the user is only given an option to abort the installation of the software. In some embodiments, the error message includes options to abort or continue the installation of the software. Further, in some other embodiments, the error message contains a browsing option for the user to select different software to install.

The error message of FIG. 3B provides the user with an option to download the latest version of the software from the corresponding website or an option to abort the installation of the software. Further, in some embodiments, in addition to providing the above-mentioned options, the error message may ask the user whether to report the error to a predetermined authority.

The error messages of FIG. 3C provides the user with an option to continue the installation and an option to abort the installation. If the user selects the option to continue the installation, the second error message window appears and provides an option to report the error before continuing the installation and an option to abort the installation. In some embodiments, the system may present one or more sequential error messages.

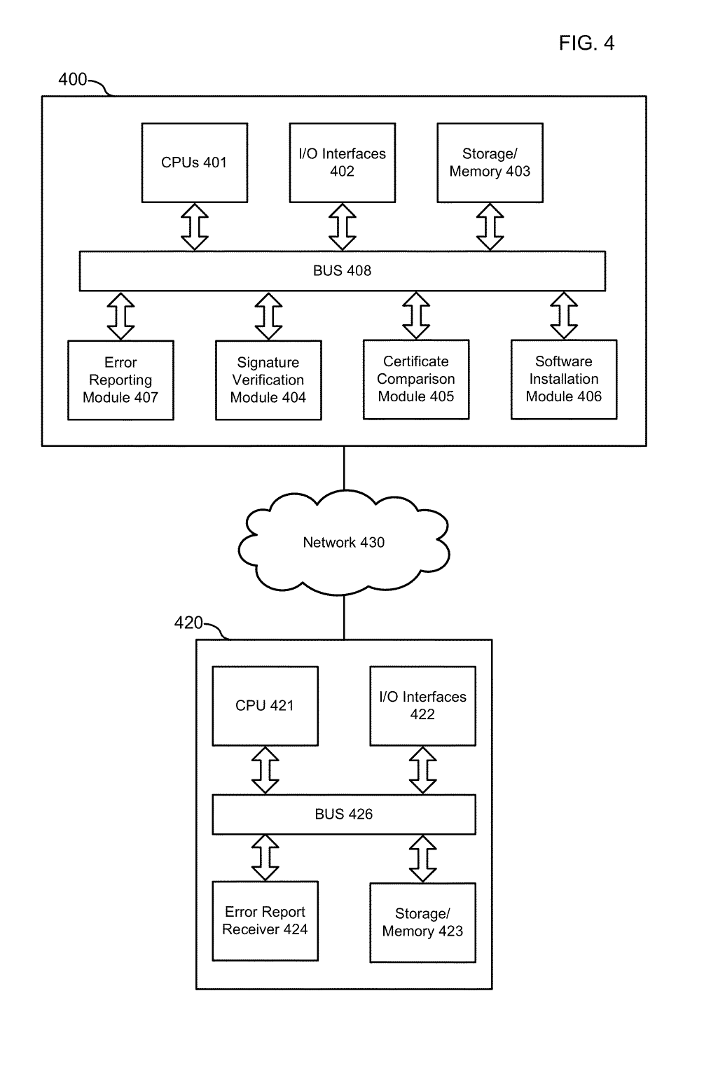

FIG. 4 illustrates an example embodiment of a system for installing software.

The system includes a computing device 400 and a server 420.

The computing device 400 includes one or more processors (CPUs) 401, one or more I/O interfaces 402, and storage/memory 403. The CPUs 401 include one or more central processing units, which include microprocessors (e.g., a single core microprocessor, a multi-core microprocessor) or other circuits, and the CPUs 401 are configured to read and perform computer-executable instructions, such as instructions in storage, in memory, or in a module. The I/O interfaces 402 include communication interfaces to input and output devices, which may include a keyboard, a display, a mouse, a printing device, a touch screen, a light pen, an optical-storage device, a scanner, a microphone, a camera, a drive, a controller (e.g., a joystick, a control pad), and a network (either wired or wireless).

The storage/memory 403 includes one or more computer-readable or computer-writable media, for example a computer-readable storage medium. A computer-readable storage medium, in contrast to a mere transitory, propagating signal, includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage/memory 403 can store computer-readable data or computer-executable instructions. The components of the computing device 400 communicate via a bus 408.

The computing device 400 also includes a signature verification module 404, a certificate comparison module 405, a software installation module 406, and an error reporting module 407. A module includes logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the devices in the system include additional or fewer modules, the modules are combined into fewer modules, or the modules are divided into more modules.

The signature verification module 404 includes instructions that, when executed, or circuits that, when activated, cause the computing device 400 to verify the validity of digital signatures on the software package and the software installation application. The certificate comparison module 405 includes instructions that, when executed, or circuits that, when activated, cause the computing device 400, when the digital signatures on the software and the software installation application are verified to be valid, to extract the public keys from the certificates of the software package and the software installation application and compare the public keys of the software package and the software installation application. The software installation module 406 includes instructions that, when executed, or circuits that, when activated, cause the computing device 400, when the public keys of the certificates of the software package and the software installation application match, to store the certificate of the software in the storage/memory 403 and install the software on the computing device 400. The error reporting module 407 includes instructions that, when executed, or circuits that, when activated, cause the computing device 400 to report the error (e.g., invalid signature, certificates not matching) and generate an error message in response to the error reported.

The server 420 includes one or more CPUs 421, I/O interfaces 422, storage/memory 423, and an error report receiver 424. The error report receiver 424 includes instructions that, when executed, or circuits that, when activated, cause the server 420 to receive, from the computing device 400, the error that occurred in the process of installing the software. The entities in the server 420 communicate via a bus 426. Further, the computing device 400 and the server 420 communicate via a network 430.

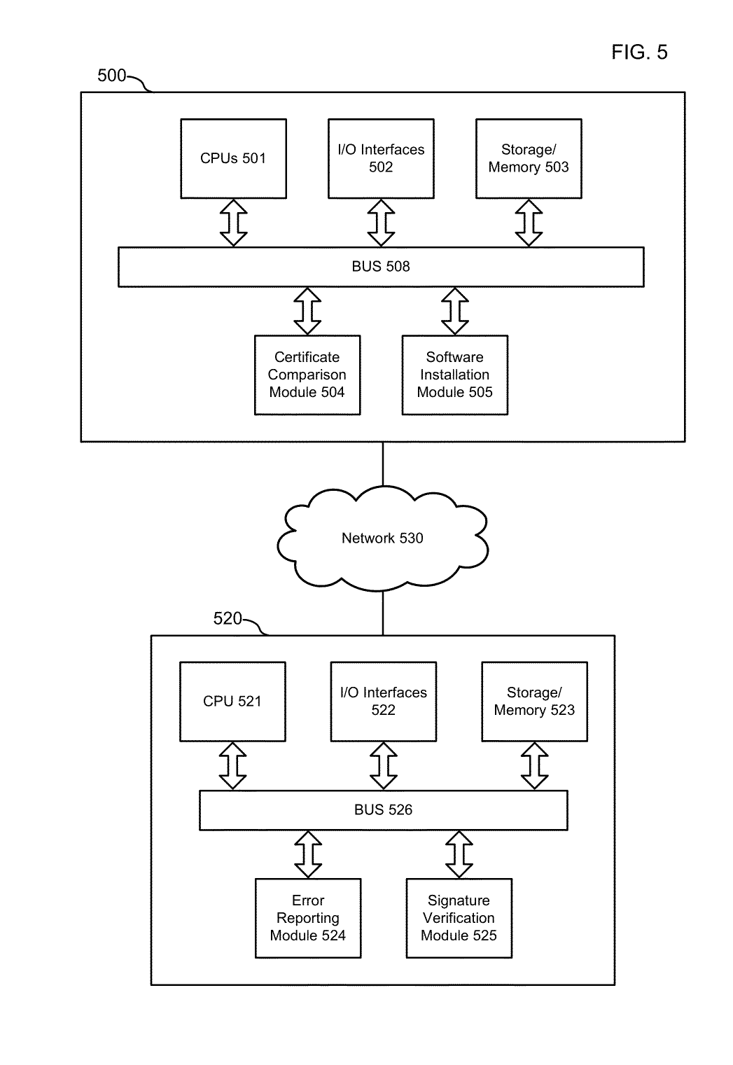

FIG. 5 illustrates an example embodiment of a system for installing software. The system includes a computing device 500 and a server 520. The computing device 500 and the server 520 communicate via a network 530.

The computing device 500 includes one or more processors (CPUs) 501, one or more I/O interfaces 502, storage/memory 503, a certificate comparison module 504, and a software installation module 505. The entities in the computing device 500 communicate via a bus 508.

The server 520 includes one or more CPUs 521, I/O interfaces 522, storage/memory 523, a signature verification module 525, and an error reporting module 524. The error reporting module 524 includes instructions that, when executed, or circuits that, when activated, cause the server 520 to receive an error signal from the computing device 500 and to send data for generating an error message to the computing device 500. The entities in the server 520 communicate via a bus 526.

The above-described devices and systems can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

1. A method for installing software, the method comprising:
receiving a request to install software included in a software package onto a computing device, wherein an installer that is installed on the computing device is used to install the software included in the software package onto the computing device;
extracting an installer signing certificate from the installer;
extracting a software signing certificate from the software package;
determining whether the software signing certificate matches the installer signing certificate; and
responsive to determining that the software signing certificate matches the installer signing certificate, installing the software included in the software package onto the computing device using the installer that is installed on the computing device.

2. The method of claim 3, further comprising:
verifying, with the signature verification service, a digital signature of the software; and
verifying, with the signature verification service, a digital signature of the installer.

3. The method of claim 1, further comprising
launching a signature verification service with the installer, wherein
extracting the installer signing certificate from the installer, extracting the software signing certificate from the software package, and determining whether the software signing certificate matches the installer signing certificate are performed by the signature verification service.

4. The method of claim 1, wherein a private key software signing certificate was used to sign the software and to sign the installer.

5. The method of claim 4, wherein the software signing certificate includes a first public key and the installation application signing certificate includes a second public key, respectively.

6. The method of claim 1, further comprising
running the installer without installing the software while extracting the installer signing certificate from the installer, extracting the software signing certificate from the software package, and determining whether the software signing certificate matches the installer signing certificate.

7. A system for installing software, the system comprising:
one or more computer-readable media; and
one or more processors that are in communication with the computer-readable media and that are configured to cause the system to
receive a request to install software included in a software package onto a computing device, wherein an installer that is installed on the computing device is used to install the software included in the software package onto the computing device;
extract an installer signing certificate from the installer;
extract a software signing certificate from the software package;
determine whether the software signing certificate matches the installation application software signing certificate; and
responsive to determining that the software signing certificate matches the installer signing certificate, install the software included in the software package onto the computing device via the installer that is installed on the computing device.

8. The system of claim 7, wherein the one or more processors are further configured to cause the system to
verify a digital signature on the software; and
verify a digital signature on the installer.

9. The system of claim 7, wherein the installer is configured to cause the system to launch a signature verification service, and
wherein the signature verification service is configured to cause the system to extract the installer signing certificate from the installer, extract the software signing certificate from the software package, and determine whether the software signing certificate matches the installation application software signing certificate.

10. The system of claim 7, wherein a private key software signing certificate was used to sign the software and to sign the installer.

11. The system of claim 10, wherein the software signing certificate and the installation application signing certificate include a public key.

12. The system of claim 7, wherein
the one or more processors are further configured to cause the system to
run the installer without installing the software while the system is caused to extract the installer signing certificate from the installer, extract the software signing certificate from the software package, and determe whether the software signing certificate matches the installer signing certificate.

13. One or more computer-readable storage media storing computer-executable instructions that, when executed by one or more computing devices, causes the one or more computing devices to perform operations comprising:
receiving a request to install software included in a software package onto a computing device, wherein an installer that is installed on the computing device is used to install the software included in the software package onto the computing device;
extracting an installer signing certificate from the installer;
extracting a software signing certificate from the software package;
determining whether the software signing certificate matches the installer signing certificate; and
responsive to determining that the software signing certificate matches the installation application software signing certificate, installing the software onto the computing device via the installer that is installed on the computing device.

14. The one or more computer-readable storage media of claim 13, wherein the operations further comprise:
verifying a digital signature on the software; and
verifying a digital signature on the installer.

15. The one or more computer-readable storage media of claim 13, wherein the operations further comprise storing the software signing certificate in a certificate store.

16. The one or more computer-readable storage media of claim 13, wherein a private key software signing certificate was used to sign the software and to sign the installer.

17. The one or more computer-readable storage media of claim 16, wherein the software signing certificate includes a first public key and the installation application signing certificate includes a second public key.

18. The one or more computer-readable storage media of claim 17, wherein determining whether the software signing certificate matches the installation application signing certificate includes comparing the first public key to the second public key.

19. The one or more computer-readable storage media of claim 13, wherein the operations further comprise:
launching a signature verification service with the installer, wherein
extracting the installer signing certificate from the installer, extracting the software signing certificate from the software package, and determining whether the software signing certificate matches the installer signing certificate are performed by the signature verification service.

20. The one or more computer-readable storage media of claim 13, wherein the operations further comprise:
running the installer without installing the software while extracting the installer signing certificate from the installer, extracting the software signing certificate from the software package, and determining whether the software signing certificate matches the installer signing certificate are performed by the signature verification service
